(19) United States
(12) Patent Application Publication
(10) Pub. No.: US 2026/0334509 A1
(43) Pub. Date: Oct. 29, 2026

(54) DOG FREEZE DRIED ANIMAL TREAT AND METHOD OF MAKING

(71) Applicant: Further Foods, Inc., Wilmington, DE (US)

(72) Inventors: Joshua Errett, Oakland, CA (US); Jonathan Cruz, Cobb, CA (US); Ashton Hood, Greensburg, IN (US)

(73) Assignee: Further Foods, Inc., Wilmington, DE (US)

(21) Appl. No.: 19/106,069

(22) PCT Filed: Aug. 15, 2023
(86) PCT No.: PCT/US2023/030286

§ 371 Date: Feb. 24, 2025

Related U.S. Application Data
(60) Provisional application No. 63/373,185, filed on Aug. 22, 2022.

(51) Int. Cl. A23K 10/18; A23K 30/20; A23K 40/00; A23K 50/42

(52) U.S. Cl. CPC A23K 10/18; A23K 30/20; A23K 40/00; A23K 50/42

(57) ABSTRACT

Solid freeze-dried animal treat compositions and methods of preparing and using the treats are disclosed. The animal treats comprise a yeast product and an Aspergillus sp. product.

### CROSS-REFERENCE TO RELATED APPLICATIONS

This application is a national stage application of International Patent Application No. PCT/US2023/030286, filed on Aug. 15, 2023, which claims the priority to U.S. Provisional Appl. Ser. No. 63/373,185, filed Aug. 22, 2022, which are incorporated herein by reference.

### FIELD OF THE INVENTION

The present disclosure provides a freeze-dried animal treat compositions and methods of producing and using the animal treat compositions.

### BACKGROUND OF THE INVENTION

Currently available animal treats intended for cats and dogs comprise animal products as dogs and cats require the high protein content normally found in animal-based treats. However, animal-based treats can be problematic because of the lack of shelf-stability, and detrimental environmental impact they produce during production. Such animal products also have inconvenient supply chain mechanics and inconsistent ingredient integrity, among other issues.

Accordingly, there is a need for animal treat products comprising an animal-free alternative protein source, is shelf-stable, is not detrimental to the environment, and which utilizes ingredients having good supply chain mechanics.

### SUMMARY OF THE INVENTION

The present disclosure is based in part on the surprising discovery by the inventor of animal treat compositions that are animal protein-free, yet shelf-stable, and nutritionally suitable and palatable to carnivorous animals, including cats. Before the instant disclosure, there were no animal-free animal treats that were shelf-stable and nutritionally suitable and highly palatable to carnivorous animals, such as cats. The animal treat compositions of the present disclosure are solid treat products capable of retaining their shape during storage and transport, that liquifies when ingested and is also highly palatable.

The present disclosure provides an animal treat composition comprising at least about 85%, about 86%, about 87%, about 88%, about 89%, about 90%, about 91%, about 92%, about 93%, about 94%, about 95%, about 96%, about 97%, about 98% or about 99% yeast product and at least about 1%, about 2%, about 3%, about 4%, about 5%, about 6%, about 7%, about 8%, about 9%, about 10%, about 11%, about 12%, about 13%, about 14% or about 15% Aspergillus sp. product. In certain embodiments the animal treat composition comprises less than 1%, less than 0.9%, less than 0.8%, less than 0.7%, less than 0.6%, less than 0.5%, less than 0.4%, less than 0.3%, less than 0.2%, less than 0.1%, or less of protein derived from an animal source. In some embodiments the animal treat composition comprises less than 1%, less than 0.9%, less than 0.8%, less than 0.7%, less than 0.6%, less than 0.5%, less than 0.4%, less than 0.3%, less than 0.2%, less than 0.1%, or less of protein derived from mammalian or insect sources. In other embodiments the animal treat composition comprises a nutritional profile similar to a meat-based animal treat.

In particular embodiments the yeast product is a deactivated yeast. In other embodiments the yeast product comprises Saccharomyces cerevisiae. In yet other embodiments the yeast product is dried yeast. In still other embodiments the yeast product and the Aspergillus sp. product are powdered forms of the yeast product and the Aspergillus sp. product. In additional embodiments the Aspergillus sp. product comprises Aspergillus niger. In certain embodiments the Aspergillus sp. product is a koji mold comprising an Aspergillus sp. In some embodiments the animal treat composition comprises at least about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49% or about 50% of protein content comes from the yeast product and the Aspergillus sp. product.

In various embodiments the animal treat composition comprises a cylindrical shape, a rectangular shape, a cuboid shape, a triangular shape, a circular shape, an elliptical shape, a polygonal shape, a polyhedral shape, or an irregular shape. In certain embodiments the animal treat composition comprises a form and size suitable for consumption by a cat. In some embodiments the animal treat composition suitable for consumption by a cat comprises a length of about ½ inch, width of about ½ inch, and a thickness of about ½ inch, or a length of about ⅜, about ¼ inch or about ⅛ inch, a width of about ⅜ inch, about ¼ inch or about ⅛ inch, and a thickness of about ⅜ inch, bout ¼ inch or about ⅛ inch. In other embodiments the animal treat composition suitable for consumption by a cat comprises different lengths, widths and thicknesses. In particular embodiments the animal treat composition suitable for consumption by a cat comprises a cylindrical shape.

In other embodiments the animal treat composition comprises a form and size suitable for consumption by a dog. In yet other embodiments the animal treat composition suitable for consumption by a dog comprises a length of about 1 inch, a width of about ½ inch, and a thickness of ⅜ inch, or a length of about ⅞ inch, about ¾ inch, about ⅝ inch, about ½ inch, about ⅜ inch or about ¼ inch, a width of about ⅜ inch or about ¼ inch, and a thickness of about ¼ inch or about ⅛ inch. In some embodiments the animal treat composition suitable for consumption by a dog comprises the same length, width and thickness. In still other embodiments the animal treat composition suitable for consumption by a dog comprises a rectangular or domino shape.

The present disclosure also provides a method of preparing an animal treat composition, the method comprising forming a paste comprising a yeast product and an Aspergillus sp. product by hydrating a dry yeast product and a dry Aspergillus sp. product with a fluid, shaping the paste to form a shaped paste, and freeze-drying the shaped paste. In certain embodiments the ratio of the dry yeast product and the dry Aspergillus sp. product to the fluid is about 10:1, about 9:1, about 8:1, about 7:1, about 6:1, about 5:1, about 4:1, about 3:1, about 2:1; about 1:1, about 1:2, about 1:3, about 1:4, about 1:5, about 1:6, about 1:7, about 1:8, about 1:9 or about 1:10. In some embodiments the fluid is water, while in other embodiments the fluid is an oil, for example a vegetable or mineral oil, or water in combination with one or more other suitable fluids, such as an oil.

In certain embodiments of the method, the shaped paste is in a form suitable for consumption by an animal. In other embodiments of the method, the shaped paste is in a form suitable for further processing. In yet other embodiments of the method, the shaped paste is formed into a sheet. In further embodiments, the method comprises cutting the sheet into strips. In some embodiments the sheet is cut before freeze-drying.

In certain embodiments of the method, the shaped paste is frozen to a temperature ranging from about −30 °F to about 10 °F. In various embodiments of the method, the shaped paste is frozen to a temperature ranging from about −20 °F to about 10 °F, from about −10 °F to about 10 °F, from about −5 °F to about 10 °F, from about 0 °F to about 10 °F, from about −30 °F to about 5 °F, from about −30 °F to about 0 °F, from about-30 °F to about −10 °F, from about −30 °F to about −20 °F, from about −20 °F to about 5 °F, from about −10 °F to about 0 °F, or a temperature of about −30 °F, about −25 °F, about −20 °F, about −15 °F, about −10 °F, about −5 °F, about 0 °F, about 5 °F or about 10 °F.

In additional embodiments, the method further comprises tempering the frozen shaped paste to a temperature ranging from about 0 °F to about 30 °F. In some embodiments, the method further comprises tempering the frozen shaped paste to a temperature ranging from about 5 °F to about 30 °F, from about 10 °F to about 30 °F, from about 15 °F to about 30 °F, from about 20 °F to about 30 °F, from about 25 °F to about 30 °F, from about 0 °F to about 25 °F, from about 0 °F to about 20 °F, from about 0 °F to about 15 °F, from about 0 °F to about 10 °F, from about 0 °F to about 5 °F, from about 5 °F to about 25 °F, from about 10 °F to about 20 °F, or about 0 °F, about 5 °F, about 10 °F, about 15 °F, about 20 °F, about 25 °F or about 30 °F.

The present disclosure additionally provides a method of feeding an animal treat composition to an animal, the method comprising feeding an animal treat composition comprising at least about 90% yeast product and at least about 5% Aspergillus sp. product to the animal, wherein the animal treat composition maintains or improves gut health and immunity. In certain embodiments the animal treat composition provides all the nutritional needs of the animal.

### DETAILED DESCRIPTION

The present disclosure is based in part on the surprising discovery by the inventor of animal treat compositions that are animal protein-free, shelf-stable, and nutritionally suitable and palatable to carnivorous animals, including cats. The animal treat compositions of the present disclosure are solid treat products capable of retaining their shape during storage and transport, that liquifies when ingested, and is also highly palatable.

The animal treat compositions of the instant disclosure use environmentally friendly and sustainable ingredients having good supply chain mechanics. The animal treat compositions of the instant disclosure provide a protein source comprising similar nutrients and/or levels of nutrients as traditional animal-based meat products with additional beneficial functionality. Importantly, the animal treat compositions comprise a high content of high-quality bioavailable functional proteins and other nutrients such as B vitamins, which are essential for gut health and immunity. Further, amino acids such as glutamate and threonine work as fuel for the enterocytes in the gastrointestinal tract while supporting the mucosal membrane and normal physiological functioning. The animal treat compositions support cognitive, arterial and heart health. The array of amino acids, including arginine, leucine, isoleucine and valine of the treat product works to support the animal's gut, arterial, heart and cognitive health.

One aspect of the instant disclosure encompasses a solid freeze-dried animal treat composition comprising a yeast product and an Aspergillus sp. product. The animal treat composition can be a replacement of traditional meat treat products normally fed to carnivorous animals and can be free of ingredients other than the yeast product and the Aspergillus sp. product. The animal treat product can also be meat protein-free, animal protein-free, insect protein-free, mammalian protein-free or free of protein derived from Kingdom Animalia sources. In some aspects, the yeast product and the Aspergillus sp. product are dry powdered forms of the yeast product and the Aspergillus sp. product.

### I. Composition

One aspect of the instant disclosure encompasses a solid freeze-dried animal treat composition comprising a yeast product and an Aspergillus sp. product. The animal treat composition can be a replacement of traditional meat treat products normally fed to carnivorous animals and can be free of ingredients other than the yeast product and the Aspergillus sp. product. The animal treat product can also be meat protein-free, animal protein-free, insect protein-free, mammalian protein-free or free of protein derived from Kingdom Animalia sources. In some aspects, the yeast product and the Aspergillus sp. product are dry powdered forms of the yeast product and the Aspergillus sp. product.

The animal can be a human, a livestock animal, a companion animal, a lab animal, or a zoological animal. In one aspect, the subject can be a rodent, e.g., a mouse, a rat, a guinea pig, etc. Non-limiting examples of suitable livestock animals may include pigs, cows, horses, goats, sheep, llamas and alpacas. As used herein, a “zoological animal” refers to any animal that may be found in a zoo. Such animals may include, but are not limited to, non-human primates, large cats, wolves, and bears. Non-limiting examples of a laboratory animal may include rodents, canines, felines, and non-human primates. In some aspects, the subject is a human subject. In some aspects, the animal is an obligate carnivorous animal. In some aspects, the animal is a companion animal. Non-limiting examples of companion animals may include pets such as dogs, cats, rabbits, guinea pigs, pot bellied pigs, and birds. In some aspects, the animal is a dog. In other aspects, the animal is a cat.

The animal treat compositions of the instant disclosure can be of any size and shape suitable for administration to an animal. It will be recognized that the size and shape of the animal can and will vary depending on the animal. Accordingly, the animal treat compositions can be of any size and shape suitable for consumption by the animal. The animal treat products can have regular shapes such as a cuboid, a conical, a cylindrical, a rectangular, a polygonal, or a disc shape, or shaped in the form of “kisses.” Alternatively, an animal treat composition of the instant disclosure can be formed into irregular shapes, or shapes that can provide some additional benefits to the animal upon chewing. For instance, the treat product can include protrusions to aid in cleaning the animal's teeth. In some aspects, an animal treat of the instant disclosure is a cuboid (including a cube or a rectangular cuboid), triangular, circular, elliptical, polyhedral, and irregular shapes. In some aspects the animal treat comprises a cuboid shape suitable for ingestion by the animal.

In some aspects, the animal treat composition comprises a form and size suitable for consumption by a dog. For instance, the animal treat composition can be a polygon or domino-shape comprising a length ranging from about ⅛ inch long to about 1 inch long or more, a width of about ⅛ inch to about ½ inch or more, and a thickness of about ⅛ inch to about ⅜ inch or more. In some aspects, the animal treat composition is a cuboid comprising a length, width and thickness of about ½ inch, about ⅝ inch or about ¾ inch.

In some aspects, the animal treat composition comprises a form and size suitable for consumption by a cat. Taste preferences and diet palatability (taste, odor, shape, mouthfeel and texture) in cats has been studied (see, e.g., Yavuz Pekel, et al., J. Appl. Anim. Res. 48:281-292, 2020, and afbinternational.com/wp-content/uploads/2022/09/Kibble-Shape-Effects-Palatability_WP_2020.pdf). For instance, the animal treat can be a cylinder comprising a length ranging from about ⅛ inch long to about ½ inch, a width of about ⅛ inch to about ½ long, and a thickness of about ⅛ inch to about ½ inch. In some aspects, the animal treat product is a cuboid comprising a length, width and thickness of about ¼ inch, about ⅜ inch or about ½ inch.

### A. Yeast Product

The animal treat compositions of the instant disclosure comprise a yeast product. The effects of yeast products on circulating immune cells and oxidative stress markers (Wilson, et al., J. Anim. Sci. 2022 Sep. 1; 100 (9): skac245. doi: 10.1093/jas/skac245), fecal characteristics, oxidative stress and blood gene expression (Wilson, et al., J. Anim. Sci. 2023, skac378, doi.org/10.1093/jas/skac378), diet digestibility, fermentative metabolites and fecal microbiota (Bastos, et al., Microorganisms 2023, 11 (2), 506; doi.org/10.3390/microorganisms11020506), intestinal health (Lin, et al., Front. Vet. Sci. frontiersin.org/articles/10.3389/fvets. 2020.597939/full) have been studied in dogs, and the effects on growth performance, rumen fermentation and immune response have been studied in weaned beef calves (Ma, et al., Anim. Nutr. 7:1352-1359, 2021). The yeast product generally has nutrient specifications similar to egg products. A yeast product suitable for an animal treat composition of the instant disclosure can comprise, without limitation, Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Candida albicans, Candida cloaceae, Candida tropicalis, Candida utilis, Geotrichum candidum, Hansenula americana, Hansenula anomala, Hansenula wingei, or any combination thereof.

The yeast product can be any yeast or yeast-derived product provided the yeast is generally regarded as safe for use in food or medical applications. In some aspects, the product is a deactivated yeast. In some aspects, the yeast product is a powdered form of a deactivated yeast. Deactivated yeast, also called nutritional yeast, is often a strain of Saccharomyces cerevisiae that is sold commercially as a food product. It is sold in the form of yellow flakes, granules, or powder and can be found in the bulk aisle of most natural food stores. It is popular with vegans and vegetarians and may be used as an ingredient in recipes or as a condiment. Deactivated yeast is a significant source of some B-complex vitamins and contains trace amounts of several other vitamins and minerals. Sometimes deactivated yeast is fortified with vitamin B12. Deactivated yeast has a strong flavor that is described as nutty or cheesy, which makes it popular as an ingredient in cheese substitutes. It is often used by vegans in place of cheese in, for example, mashed and fried potatoes or scrambled tofu, or as a topping for popcorn. Deactivated yeast is a whole-cell inactive yeast that contains both soluble and insoluble parts. In some aspects, the yeast product of the instant disclosure is deactivated yeast in a dry powdered form.

The yeast product can be dried powdered yeast product. In some aspects, the yeast product comprises a Saccharomyces sp. yeast. In some aspects, the yeast product comprises Saccharomyces cerevisiae. In some aspects, the yeast product comprises deactivated Saccharomyces cerevisiae.

B. Aspergillus sp. Product

The animal treat compositions of the instant disclosure also comprise an Aspergillus sp. product. An Aspergillus sp. product suitable for an animal treat composition of the instant disclosure can comprise, without limitation, Aspergillus acidohumus, Aspergillus acidus, Aspergillus aculeatinus, Aspergillus aculeatus, Aspergillus aeneus, Aspergillus affinis, Aspergillus alabamensis, Aspergillus albertensis, Aspergillus alliaceus, Aspergillus amazonicus, Aspergillus ambiguus, Aspergillus amoenus, Aspergillus amstelodami, Aspergillus amyloliquefaciens, Aspergillus amylovorus, Aspergillus anomalus, Aspergillus anthodesmis, Aspergillus angustatus, Aspergillus apicalis, Aspergillus appendiculatus, Aspergillus arachidicola, Aspergillus ardalensis, Aspergillus arenarius, Aspergillus arvii, Aspergillus askiburgiensis, Aspergillus asperescens, Aspergillus assulatus, Aspergillus astellatus, Aspergillus aurantiobrunneus, Aspergillus aurantiopurpureus, Aspergillus aureolatus, Aspergillus aureoterreus, Aspergillus aureus, Aspergillus auricomus, Aspergillus australensis, Aspergillus austroafricanus, Aspergillus avenaceus, Aspergillus awamori, Aspergillus baarnensis, Aspergillus baeticus, Aspergillus bahamensis, Aspergillus bertholletius, Aspergillus biplanus, Aspergillus bisporus, Aspergillus bombycis, Aspergillus botswanensis, Aspergillus brasiliensis, Aspergillus brevistipitatus, Aspergillus brevijanus, Aspergillus brevipes, Aspergillus brevistipitatus, Aspergillus bridgeri, Aspergillus brunneo-uniseriatus, Aspergillus brunneus, Aspergillus brunneoviolaceus, Aspergillus caatingaensis, Aspergillus caelatus, Aspergillus caesiellus, Aspergillus caespitosus, Aspergillus calidoustus, Aspergillus californicus, Aspergillus campestris, Aspergillus candidus, Aspergillus caninus, Aspergillus capensis, Aspergillus capsici, Aspergillus carbonarius, Aspergillus carneus, Aspergillus carlsbadensis, Aspergillus cejpii, Aspergillus cavernicola, Aspergillus cervinus, Aspergillus chevalieri, Aspergillus chinensis, Aspergillus chungii, Aspergillus cibarius, Aspergillus citrinoterreus, Aspergillus clavatoflavus, Aspergillus clavatonanicus, Aspergillus clavatus, Aspergillus cleistominutus, Aspergillus conicus, Aspergillus conjunctus, Aspergillus conversis, Aspergillus coreanus, Aspergillus coremiiformis, Aspergillus costaricensis, Aspergillus costiformis, Aspergillus creber, Aspergillus cremeus, Aspergillus cretensis, Aspergillus cristatus, Aspergillus crustosus, Aspergillus crystallinus, Aspergillus cumulatus, Aspergillus cvjetkovicii, Aspergillus deflectus, Aspergillus delacroixii, Aspergillus delicatus, Aspergillus densus, Aspergillus dentatulus, Aspergillus depauperatus, Aspergillus dessyi, Aspergillus destruens, Aspergillus digitatus, Aspergillus dimorphicus, Aspergillus diplocystis, Aspergillus discophorus, Aspergillus disjunctus, Aspergillus desertorum, Aspergillus diversus, Aspergillus dorothicus, Aspergillus dromiae, Aspergillus dubius, Aspergillus duricaulis, Aspergillus dybowskii, Aspergillus eburneocremeus, Aspergillus eburneus, Aspergillus echinosporus, Aspergillus echinulatus, Aspergillus ecuadorensis, Aspergillus effusus, Aspergillus egyptiacus, Aspergillus elatior, Aspergillus elegans, Aspergillus ellipsoideus, Aspergillus ellipticus, Aspergillus elongatus, Aspergillus equitis, Aspergillus erythrocephalus, Aspergillus eucalypticola, Aspergillus europaeus, Aspergillus falconensis, Aspergillus fasciculatus, Aspergillus felis, Aspergillus fennelliae, Aspergillus ferenczii, Aspergillus ferrugineus, Aspergillus ficuum, Aspergillus fiemonthi, Aspergillus fijiensis, Aspergillus filifera, Aspergillus fimetarius, Aspergillus fimeti, Aspergillus fischeri, Aspergillus fischerianus, Aspergillus flaschentraegeri, Aspergillus flavescens, Aspergillus flavidus, Aspergillus flavipes, Aspergillus flavofurcatus, Aspergillus flavoviridescens, Aspergillus flavus, Aspergillus floccosus, Aspergillus floridensis, Aspergillus floriformis, Aspergillus foeniculicola, Aspergillus foetidus, Aspergillus fonsecaeus, Aspergillus foutoynontii, Aspergillus foveolatus, Aspergillus fresenii, Aspergillus fructus, Aspergillus fruticans, Aspergillus fruticulosus, Aspergillus fujiokensis, Aspergillus fuliginosus, Aspergillus fulvus, Aspergillus fumaricus, Aspergillus fumigatiaffinis, Aspergillus fumigatoides, Aspergillus fumigatus, Aspergillus fumisynnematus, Aspergillus fungoides, Aspergillus funiculosus, Aspergillus fuscus, Aspergillus galapagensis, Aspergillus galeritus, Aspergillus germanicus, Aspergillus giganteus, Aspergillus gigantosulphureus, Aspergillus gigas, Aspergillus glaber, Aspergillus glabripes, Aspergillus glaucoaffinis, Aspergillus glauconiveus, Aspergillus glaucus, Aspergillus globosus, Aspergillus godfrini, Aspergillus gorakhpurensis, Aspergillus gracilis, Aspergillus granulatus, Aspergillus granulosus, Aspergillus gratioti, Aspergillus greconis, Aspergillus griseus, Aspergillus guttifer, Aspergillus gymnosardae, Aspergillus halophilicus, Aspergillus halophilus, Aspergillus helicothrix, Aspergillus hennebergii, Aspergillus herbariorum, Aspergillus heterocaryoticus, Aspergillus heteromorphus, Aspergillus heterothallicus, Aspergillus heyangensis, Aspergillus hiratsukae, Aspergillus haitiensis, Aspergillus hollandicus, Aspergillus homomorphus, Aspergillus hordei, Aspergillus hortae, Aspergillus hortai, Aspergillus huiyaniae, Aspergillus humicola, Aspergillus humus, Aspergillus ibericus, Aspergillus igneus, Aspergillus iizukae, Aspergillus implicatus, Aspergillus incrassatus, Aspergillus indicus, Aspergillus indohii, Aspergillus indologenus, Aspergillus inflatus, Aspergillus ingratus, Aspergillus insecticola, Aspergillus insolitus, Aspergillus insuetus, Aspergillus insulicola, Aspergillus intermedius, Aspergillus inuii, Aspergillus itaconicus, Aspergillus ivoriensis, Aspergillus jaipurensis, Aspergillus janus, Aspergillus japonicus, Aspergillus jeanselmei, Aspergillus jensenii, Aspergillus kambarensis, Aspergillus kanagawaensis, Aspergillus kassunensis, Aspergillus katsuobushi, Aspergillus keveii, Aspergillus koningii, Aspergillus laciniosus, Aspergillus lacticoffeatus, Aspergillus laneus, Aspergillus lanosus, Aspergillus laokiashanensis, Aspergillus lateralis, Aspergillus lentulus, Aspergillus lepidophyton, Aspergillus leporis, Aspergillus leucocarpus, Aspergillus levisporus, Aspergillus lignieresii, Aspergillus longivesica, Aspergillus longobasidia, Aspergillus luchensi, Aspergillus luchuensis, Aspergillus lucknowensis, Aspergillus luppii, Aspergillus luteoniger, Aspergillus luteovirescens, Aspergillus lutescens, Aspergillus luteus, Aspergillus macfiei, Aspergillus macrosporus, Aspergillus magnivesiculatus, Aspergillus malignus, Aspergillus malodoratus, Aspergillus malvaceus, Aspergillus mandshuricus, Aspergillus mangaliensis, Aspergillus manginii, Aspergillus mannitosus, Aspergillus maritimus, Aspergillus marvanovae, Aspergillus mattletii, Aspergillus maximus, Aspergillus medius, Aspergillus melitensis, Aspergillus melleus, Aspergillus mellinus, Aspergillus mencieri, Aspergillus michelii, Aspergillus microcephalus, Aspergillus microcysticus, Aspergillus micronesiensis, Aspergillus microsporus, Aspergillus microthecius, Aspergillus microviridicitrinus, Aspergillus minimus, Aspergillus minisclerotigenes, Aspergillus minor, Aspergillus minutus, Aspergillus miyajii, Aspergillus miyakoensis, Aspergillus mollis, Aspergillus monodii, Aspergillus montenegroi, Aspergillus montevidensis, Aspergillus mottae, Aspergillus mucoroides, Aspergillus mucoroideus, Aspergillus muelleri, Aspergillus multicolor, Aspergillus multiplicatus, Aspergillus muricatus, Aspergillus muscivora, Aspergillus mutabilis, Aspergillus mycetomi-villabruzzii, Aspergillus mycobanche, Aspergillus nakazawae, Aspergillus nantae, Aspergillus nanus, Aspergillus navahoensis, Aspergillus neoafricanus, Aspergillus neoauricomus, Aspergillus neobridgeri, Aspergillus neocarnoyi, Aspergillus neoechinulatus, Aspergillus neoellipticus, Aspergillus neoglaber, Aspergillus neoindicus, Aspergillus neoniger, Aspergillus neoniveus, Aspergillus nidulans, Aspergillus nidulellus, Aspergillus niger, Aspergillus nigrescens, Aspergillus nigricans, Aspergillus nishimurae, Aspergillus niveoglaucus, Aspergillus niveus, Aspergillus noelting, Aspergillus nominus, Aspergillus nomius, Aspergillus novoparasiticus, Aspergillus novofumigatus, Aspergillus novus, Aspergillus occultus, Aspergillus ochraceopetaliformis, Aspergillus ochraceoroseus, Aspergillus ochraceoruber, Aspergillus ochraceus, Aspergillus oerlinghausenensis, Aspergillus okazakii, Aspergillus olivaceofuscus, Aspergillus olivaceus, Aspergillus olivascens, Aspergillus olivicola, Aspergillus omanensis, Aspergillus onikii, Aspergillus oosporus, Aspergillus ornatulus, Aspergillus ornatus, Aspergillus oryzae, Aspergillus osmophilus, Aspergillus ostianus, Aspergillus otanii, Aspergillus ovalispermus, Aspergillus pachycaulis, Aspergillus pachycristatus, Aspergillus paleaceus, Aspergillus pallidofulvus, Aspergillus pallidus, Aspergillus panamensis, Aspergillus papuensis, Aspergillus paradoxus, Aspergillus parafelis, Aspergillus parasiticus, Aspergillus parrulus, Aspergillus parvathecius, Aspergillus parvisclerotigenus, Aspergillus parviverruculosus, Aspergillus parvulus, Aspergillus paulistensi, Aspergillus penicillatus, Aspergillus penicilliformis, Aspergillus penicillioides, Aspergillus penicillioideum, Aspergillus penicillopsis, Aspergillus periconioides, Aspergillus pernambucoensis, Aspergillus perniciosus, Aspergillus persii, Aspergillus petersonii, Aspergillus petrakii, Aspergillus peyronelii, Aspergillus phaeocephalus, Aspergillus phialiseptatus, Aspergillus phoenicis, Aspergillus pidoplichknovii, Aspergillus piperis, Aspergillus pisci, Aspergillus pluriseminatus, Aspergillus polychromus, Aspergillus polyporicola, Aspergillus porphyreostipitatus, Aspergillus pouchetii, Aspergillus primulinus, Aspergillus profusus, Aspergillus proliferans, Aspergillus protuberus, Aspergillus posadasensis, Aspergillus pragensis, Aspergillus pseudocaelatus, Aspergillus pseudocarbonarius, Aspergillus pseudocitricus, Aspergillus pseudoclavatus, Aspergillus pseudodeflectus, Aspergillus pseudoelatior, Aspergillus pseudoelegans, Aspergillus pseudoflavus, Aspergillus pseudoglaucus, Aspergillus pseudoheteromorphus, Aspergillus pseudoniger, Aspergillus pseudonomius, Aspergillus pseudotamarii, Aspergillus pseudoviridinutans, Aspergillus pulchellus, Aspergillus pulmonum-hominis, Aspergillus pulverulentus, Aspergillus pulvericola, Aspergillus pulvinus, Aspergillus puniceus, Aspergillus purpureofuscus, Aspergillus purpureus, Aspergillus pusillus, Aspergillus puulaauensis, Aspergillus pyramidus, Aspergillus pyri, Aspergillus qinqixianii, Aspergillus qizutongii, Aspergillus quadricinctus, Aspergillus quadricingens, Aspergillus quadrifidus, Aspergillus quadrilineatus, Aspergillus quercinus, Aspergillus quininae, Aspergillus quitensis, Aspergillus racemosus, Aspergillus raianus, Aspergillus rambellii, Aspergillus ramosus, Aspergillus raperi, Aspergillus recurvatus, Aspergillus rehmii, Aspergillus repandus, Aspergillus repens, Aspergillus reptans, Aspergillus restrictus, Aspergillus reticulatus, Aspergillus rhizopodus, Aspergillus robustus, Aspergillus roseoglobosus, Aspergillus roseoglobulosus, Aspergillus roseovelutinus, Aspergillus roseus, Aspergillus ruber, Aspergillus rubrobrunneus, Aspergillus rubrum, Aspergillus rufescens, Aspergillus rugulosus, Aspergillus rugulovalvus, Aspergillus rutilans, Aspergillus sacchari, Aspergillus saccharolyticus, Aspergillus saitoi, Aspergillus salwaensis, Aspergillus sclerotialis, Aspergillus salviicola, Aspergillus sartoryi, Aspergillus savannensis, Aspergillus scheelei, Aspergillus schiemanniae, Aspergillus sclerogenus, Aspergillus sclerotiicarbonarius, Aspergillus sclerotioniger, Aspergillus sclerotiorum, Aspergillus sejunctus, Aspergillus septatus, Aspergillus sepultus, Aspergillus sergii, Aspergillus sesamicola, Aspergillus shendaweii, Aspergillus siamensis, Aspergillus silvaticus, Aspergillus similis, Aspergillus simplex, Aspergillus sloanii, Aspergillus solicola, Aspergillus sojae, Aspergillus sparsus, Aspergillus spathulatus, Aspergillus spectabilis, Aspergillus spelaeus, Aspergillus spelunceus, Aspergillus spiculosus, Aspergillus spinosus, Aspergillus spinulosus, Aspergillus spiralis, Aspergillus stella-maris, Aspergillus stellatus, Aspergillus stellifer, Aspergillus stercorarius, Aspergillus sterigmatophorus, Aspergillus steynii, Aspergillus stramenius, Aspergillus striatulus, Aspergillus striatus, Aspergillus stromatoides, Aspergillus strychni, Aspergillus subalbidus, Aspergillus subfuscus, Aspergillus subgriseus, Aspergillus sublatus, Aspergillus sublevisporus, Aspergillus subolivaceus, Aspergillus subramanianii, Aspergillus subsessilis, Aspergillus subunguis, Aspergillus subversicolor, Aspergillus sulphureoviridis, Aspergillus sulphureus, Aspergillus sunderbanii, Aspergillus sydowii, Aspergillus sylvaticus, Aspergillus syncephalis, Aspergillus tabacinus, Aspergillus taichungensis, Aspergillus takakii, Aspergillus taklimakanensis, Aspergillus tamari, Aspergillus tanneri, Aspergillus tapirirae, Aspergillus tardus, Aspergillus tatenoi, Aspergillus templicola, Aspergillus tennesseensis, Aspergillus terrestris, Aspergillus terreus, Aspergillus terricola, Aspergillus testaceocolorans, Aspergillus tetrazonus, Aspergillus thermomutatus, Aspergillus thomi, Aspergillus tiraboschii, Aspergillus togoensis, Aspergillus tokelau, Aspergillus tonophilus, Aspergillus toxicarius, Aspergillus transcarpathicus, Aspergillus trinidadensis, Aspergillus tritici, Aspergillus tsurutae, Aspergillus tuberculatus, Aspergillus tubingensis, Aspergillus tunetanus, Aspergillus turcosus, Aspergillus udagawae, Aspergillus umbrinus, Aspergillus umbrosus, Aspergillus undulatus, Aspergillus unguis, Aspergillus unilateralis, Aspergillus usamii, Aspergillus ustilago, Aspergillus ustus, Aspergillus uvarum, Aspergillus vadensis, Aspergillus vancampenhoutii, Aspergillus varanasensis, Aspergillus variabilis, Aspergillus varians, Aspergillus variecolor, Aspergillus variegatus, Aspergillus velutinus, Aspergillus venenatus, Aspergillus venezuelensis, Aspergillus versicolor, Aspergillus vinosobubalinus, Aspergillus violaceobrunneus, Aspergillus violaceofuscus, Aspergillus violaceus, Aspergillus virens, Aspergillus viridigriseus, Aspergillus viridinutans, Aspergillus vitellinus, Aspergillus vitis, Aspergillus vitricola, Aspergillus waksmanii, Aspergillus wangduanlii, Aspergillus warcupii, Aspergillus wehmeri, Aspergillus welwitschiae, Aspergillus wentii, Aspergillus westendorpii, Aspergillus westlandensis, Aspergillus westerdijkiae, Aspergillus wyomingensis, Aspergillus xerophilus, Aspergillus yezoensis, Aspergillus zhaoqingensis, Aspergillus zonatus, or any combination thereof. In some aspects, the Aspergillus sp. product comprises Aspergillus niger.

In some aspects, the Aspergillus sp. product is a fermented mold comprising one or more Aspergillus sp. A fermented mold comprising one or more Aspergillus sp. can support digestion stemming from the fermentation process. This process results in trillions of beneficial bacteria and their metabolites being produced in the product. Additionally, the product from the fermentation process is predigested, which means less work for pets when digesting it themselves. The fermentation process also produces key nutrients, such as B vitamins, niacin, biotin, folic acid and over a dozen highly digestible amino acids, which all collectively work to support animal's gut health and immune systems.

In some aspects, the Aspergillus sp. product is a koji mold fermented product comprising an Aspergillus sp. A koji mold is a type of edible mold culture made up of mostly Aspergillus oryzae and is used in many food applications to ferment soy sauce, miso, sake, and other common Japanese fermented foods. The koji releases a suite of protease and amylase enzymes into the raw material mixture. The proteases cause the soy and wheat proteins to hydrolyze into amino acids and small peptides. The amylases convert starches in the wheat into simple sugars, which provide energy for the koji to live and imparts sweetness to the soy sauce. In some aspects, the Aspergillus sp. product is a koji mold comprising Aspergillus niger. In some aspects, the Aspergillus sp. product is a dried Aspergillus niger product of solid state fermentation (SSF), which is a protein source having nutrient specifications that are similar to meats like beef and lamb while being made through a natural fermentation process, allowing for a consistent delivery of nutrients along with functional properties that aren't available in traditional meat options.

The animal treat can comprise about 5% or less, about 4% or less, about 3% or less, about 2% or less, about 1% or less, or about 0.5% or less Aspergillus sp. product. In some aspects, the animal treat composition comprises about 2% or less Aspergillus sp. product. In some aspects, the animal treat compositions comprise 92% or more yeast product.

### II. Methods

Another aspect of the instant disclosure encompasses a method of preparing a solid freeze-dried animal treat composition. The method comprises the steps of (a) forming a paste comprising a yeast product, an Aspergillus sp. product and essential nutrients by hydrating a dry yeast product and a dry Aspergillus sp. product with a fluid; (b) shaping the paste to form a shaped paste; and (c) freeze-drying the shaped paste. The dry yeast product and the dry Aspergillus sp. product can be combined with the fluid in a volume ratio of about 1 part fluid to about 5 parts powder dry yeast product and powder dry Aspergillus sp. product or any other ratio of fluid to powder that can produce a paste comprising a consistency suitable for shaping and further processing. In some aspects, the fluid is water.

The shaped paste can be in a form suitable for further processing. For instance, the paste can be shaped into a form suitable for consumption by the animal, or into a shape suitable for freezing to further shape the paste. When the paste is shaped into a shape suitable for freezing to further shape the paste, the paste can be shaped into a sheet and cut into strips for freezing before dicing the strips of frozen shaped paste into a form suitable for consumption by the animal. A form suitable for consumption by the animal can be as described herein above.

In some aspects, the method of the instant disclosure further comprises freezing the shaped paste to form a frozen paste. In general, the paste is shaped into a form suitable for consumption by the animal before freeze drying. In some aspects, the paste is frozen before shaping the paste shaped into a form suitable for consumption by the animal before freeze drying. Alternatively, the paste can be shaped into a form suitable for consumption by the animal before freezing. The shaped paste can be frozen to a temperature ranging from about −30 °F to about 10 °F, from about −25 °F to about 5 °F, from about −20 °F to about 0 °F, from about −15 °F to about −5 °F, or from about −12 °F to about −8 °F. In some aspects, the shaped paste is frozen to a temperature of about −10 °F.

When the paste is frozen, the method can also further comprise tempering the paste before or after freeze-drying. The paste can be tempered to a temperature ranging from about 0 °F to about 30 °F, from about 5 °F to about 25 °F, from about 10 °F to about 20 °F, or from about 12 °F to about 17 °F. In some aspects, the paste is tempered to a temperature of about 15 °F.

Yet another aspect of the instant disclosure encompasses a method of feeding an animal a meat-free animal treat product. The method comprises feeding the animal a solid freeze-dried animal treat product, wherein the a meat-free animal treat product maintains or improves gut health and immunity, or any combination thereof.

### DEFINITIONS

The use of the word “a,” “an,” “the” or “said,” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least +1, 2, 3, 4, 5, 6, 7, 10, 12 or 15%.

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

### EXAMPLES

The following examples are included to demonstrate illustrative embodiments of the present disclosure. It should be appreciated by those of skill in the art that the techniques disclosed in the examples that follow represent techniques discovered by the inventor to function well in the practice of the present disclosure, and thus can be considered to constitute one embodiment of modes for its practice. However, those of skill in the art should, in light of the present disclosure, appreciate that many changes can be made in the specific embodiments that are disclosed and still obtain a like or similar result without departing from the spirit and scope of the present disclosure. As various changes could be made in the above-described compositions and methods without departing from the scope of the present disclosure, it is intended that all matter contained in the above description and in the examples given below, shall be interpreted as illustrative and not in a limiting sense.

### Example 1. Method of Preparing a Freeze-Dried Yeast Product for Cats and Dogs

To arrive at a meat-free freeze-dried treat for cats and dogs, 90-95% dried, nutritional yeast (Saccharomyces cerevisiae) and 5-10% koji (dried Aspergillus niger fermentation product) were blended together in powdered, dry form to form a yeast blend. Water was then added to the yeast blend and the yeast blend was frozen at the temperature of 12-14 °F to create a dense, thick, wet textured paste. This paste was then diced into various shapes and sizes using a custom dicing machine, depending on the final desired size of product, while still at a frozen temperature to maintain texture. The diced product was placed in a freeze dryer for 12-20 hours to have moisture removed which allowed it to maintain shelf stability and brittleness. Importantly, to date, there is no current freeze-dried treatment of a powdered product on the pet market.

Some steps in the method include:
1. The dry yeast was weighed into batches and placed into a bowl mixer for mixing while fluid was slowly added to ensure uniform consistency and mixing. This step was about 1 part fluid to 5 parts powder.
2. Once the last amount of fluid was added, mixing continued until the powder was fully blended and a yeast paste was formed.
3. The yeast paste was then removed from the bowl and run through a forming machine. The paste was then placed into holding containers for deep freezing.
4. Once the yeast product reached a temperature of −10 °F, it was moved to a tempering freezer. The tempering freezer was set at 15 °F and it took 2-3 days to slowly increase the temperature of the yeast product to 15 °F.
5. When the yeast product reached a temperature of 15 °F, it was removed from the tempering freezer and run through a CMD 3D Dicer for dicing. Depending on specifications, the product could be diced at ¼ inch up to ½ inch.
6. Once the product was diced into the desired size, it was quickly trayed and moved into a freezer to avoid “melting” out of form.
7. After the diced product was frozen it was loaded into a freeze dryer where a gentle drying approach was applied to ensure the final integrity of the product.

### Example 2. Nutritional Analysis of an Animal Treat

The nutritional values of an animal treat prepared as described in Example 1 was analyzed. The nutritional values represent the mean of several batches. The results are shown in Table 1.

TABLE 1
Typical Nutritional Profile (As Is Basis)

| Energy | |
|---|---|
| Crude Fat, % | 0.4 |
| NFE, % | 22.92 |
| Acid Detergent Fiber, % | 18 |
| Protein, Amino Acids | |
| Crude Protein, % | 44 |
| Amino Acids, % | |
| Lysine | 2.43 |
| Alanine | 2.54 |
| Arginine | 2.33 |
| Aspartic Acid | 3.75 |
| Cystine | 0.51 |
| Glutamic Acid | 5.56 |
| Glycine | 1.88 |
| Histidine | 0.96 |
| Isoleucine | 1.61 |
| Leucine | 2.90 |
| Methionine | 0.55 |
| Phenylalanine | 1.72 |
| Proline | 2.01 |
| Serine | 2.26 |
| Threonine | 1.92 |
| Tyrosine | 1.44 |
| Valine | 2.11 |
| Tryptophan | 0.54 |
| Major Minerals | |
| Total Ash, % | 7.78 |
| Sulfur, % | 0.40 |
| Sodium, % | 0.02 |
| Phosphorus, % | 1.29 |
| Potassium, % | 1.60 |
| Magnesium, % | 0.23 |
| Calcium, % | 0.37 |
| Trace Minerals, ppm | |
| Iron | 77.4 |
| Copper | 16.9 |
| Zinc | 94.5 |
| Manganese | 21.2 |

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. For example, all of the disclosed components of the preferred and alternative embodiments are interchangeable providing disclosure herein of many systems having combinations of all the preferred and alternative embodiment components. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. All such similar substitutes and modifications apparent to those skilled in the art are deemed to be within the spirit, scope and concept of the disclosure as defined by the appended claims.

What is claimed is:

1. An animal treat composition comprising at least about 90% yeast product and at least about 5% Aspergillus sp. product.

2. The animal treat of claim 1, wherein the animal treat composition comprises less than 1% of protein derived from an animal source.

3. The animal treat composition of claim 1, wherein the animal treat composition comprises less than 1% of protein derived from mammalian or insect sources.

4. The animal treat composition of claim 1, wherein the yeast product is a deactivated yeast.

5. The animal treat composition of claim 1, wherein the yeast product comprises Saccharomyces cerevisiae.

6. The animal treat composition of claim 1, wherein the yeast product is dried yeast.

7. The animal treat composition of claim 1, wherein the yeast product and the Aspergillus sp. product are powdered forms of the yeast product and the Aspergillus sp. product.

8. The animal treat composition of claim 1, wherein the Aspergillus sp. product comprises Aspergillus niger.

9. The animal treat composition of claim 1, wherein the Aspergillus sp. product is a koji mold comprising an Aspergillus sp.

10. The animal treat composition of claim 1, wherein the animal treat composition comprises a cylindrical shape, a rectangular shape, a cuboid shape, a triangular shape, a circular shape, an elliptical shape, a polygonal shape, a polyhedral shape, or an irregular shape.

11. The animal treat composition of claim 1, wherein the animal treat composition comprises a form and size suitable for consumption by a cat.

12. The animal treat composition of claim 11, wherein the animal treat composition comprises a length of about ½ inch, width of about ½ inch, and a thickness of about ½ inch.

13. The animal treat composition of claim 10, wherein the animal treat composition comprises a cylindrical shape.

14. The animal treat composition of claim 1, wherein the animal treat composition comprises a form and size suitable for consumption by a dog.

15. The animal treat composition of claim 14, wherein the animal treat composition comprises a length of about 1 inch, a width of about ½ inch, and a thickness of ⅜ inch.

16. The animal treat composition of claim 10, wherein the animal treat composition comprises a rectangular shape.

17. The animal treat composition of claim 1, wherein the animal treat composition comprises a nutritional profile similar to a meat-based animal treat.

18. A method of preparing an animal treat composition, the method comprising:
a. forming a paste comprising a yeast product and an Aspergillus sp. product by hydrating a dry yeast product and a dry Aspergillus sp. product with a fluid;
b. shaping the paste to form a shaped paste; and
C. freeze-drying the shaped paste.

19. The method of claim 18, wherein the ratio of the dry yeast product and the dry Aspergillus sp. product to the fluid is about 5:1.

20. A method of feeding an animal treat composition to an animal, the method comprising feeding the animal treat composition of claim 1 to the animal, wherein the animal treat composition maintains or improves gut health and immunity.
